(19) United States
(12) Patent Application Publication
(10) Pub. No.: US 2010/0134430 A1
(43) Pub. Date: Jun. 3, 2010

(54) TOUCH RESPONSIVE ELECTRONIC DEVICE

(75) Inventors: CHIANG-KUO TANG, Tu-Cheng (TW); XIAO-GUANG LI, Shenzhen City (CN); TE-YUAN KUNG, Tu-Cheng (TW); KUAN-HONG HSIEH, Tu-Cheng (TW); HAN-CHE WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/485,011

(22) Filed: Jun. 15, 2009

(30) Foreign Application Priority Data
Nov. 28, 2008 (CN) 200820303004.7

(51) Int. Cl. G06F 3/041

(52) U.S. Cl. 345/173

(57) ABSTRACT

An electronic device is provided. The electronic device comprises a housing, a plurality of touch sensors, and a processing unit. The housing comprises a plurality of touch areas and division portions, each of which is disposed between two adjacent touch areas of the plurality of touch areas. The plurality of touch sensors are disposed within the housing, each of which corresponds to one of the plurality of touch sensors. The processing unit is capable of identifying signals from the plurality of touch sensors and performing functions corresponding to the signals.

### BACKGROUND

1. Technical Field

The present disclosure relates to electronic devices and, more particularly, to a touch responsive electronic device.

2. Description of Related Art

Touch responsive electronic apparatuses are common, such as some MP3 players and cellular phones with a touch screen. For example, users can slide their finger on touch sensing areas of an apparatus to move menu items. The amount of movement of the menu items corresponds to the amount of sliding movement of the finger. However, it is usually difficult for the users to exactly control the amount of the sliding movement, which results in difficulty to exactly control the amount of movement of the menu items.

### BRIEF DESCRIPTION OF THE DRAWINGS

The components in the drawings are not necessarily drawn to scale, the emphasis instead being placed upon clearly illustrating the principles of the touch responsive electronic device. Moreover, in the drawings, like reference numerals designate corresponding parts throughout the several views.

FIG. 1 is a block diagram of a hardware infrastructure of a touch responsive electronic device in accordance with an exemplary embodiment.

FIG. 2 illustrates a front view of the electronic device of FIG. 1 in accordance with an exemplary embodiment.

FIG. 3 is a partial and enlarged view of the electronic device of FIG. 2.

FIG. 4 is a partial and enlarged view of the electronic device of FIG. 1 in accordance with another embodiment.

FIG. 5 shows an exemplary user interface displayed on the electronic device of FIG. 2.

### DETAILED DESCRIPTION

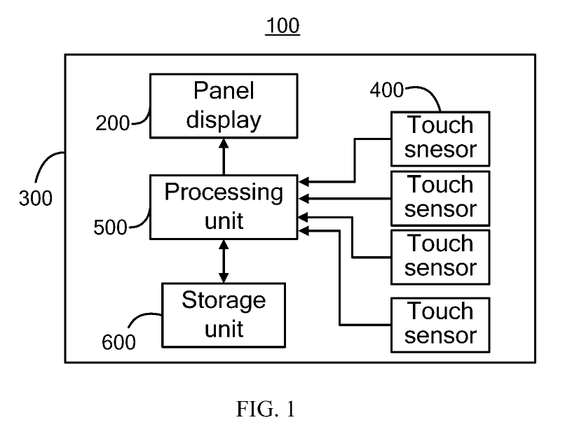

FIG. 1 shows a block diagram of a hardware infrastructure of a touch responsive electronic device 100 in accordance with an exemplary embodiment. In this embodiment, a digital photo frame is taken as the electronic device 100 for example. The digital photo frame 100 includes a panel display 200, a housing 300, a plurality of touch sensors 400 disposed within the housing 300, a processing unit 500, and a storage unit 600.

The housing 300 includes a plurality of touch areas, each of which corresponds to one of the plurality of touch sensors 400, that is, when a touch area is touched by a user's finger or a stylus for example, the touch sensor 400 corresponding to the touch area is activated.

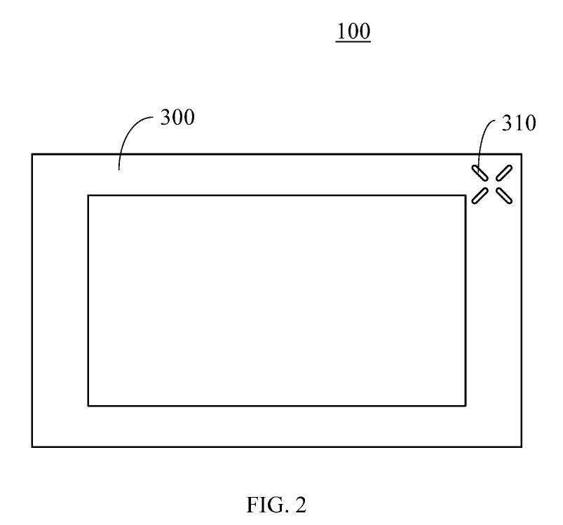

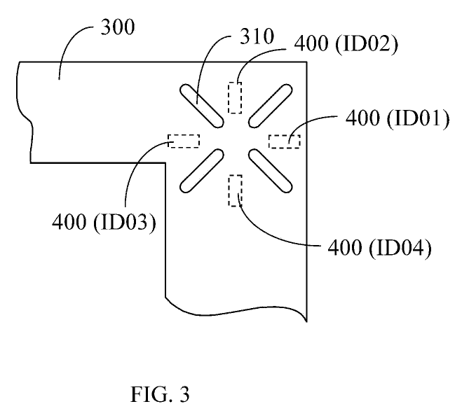

The housing 300 also includes a plurality of division portions 310 as shown in FIGS. 2 and 3. Each of the division portions 310 is arranged between two adjacent touch areas. That is, the division portions 310 are configured to separate two adjacent touch areas to some extent. When a user slides his finger from one touch area to an adjacent touch area, the division portion 310 between the two touch areas provides a tactile sensation that enables the user to determine whether they have provided a strong enough touch to activate the touch sensor 400.

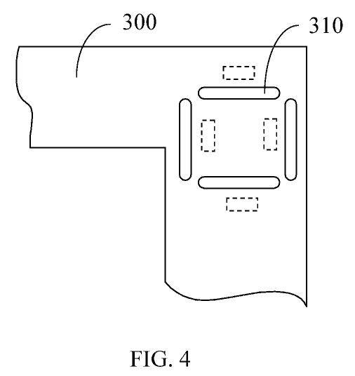

In the embodiment as shown in FIGS. 2 and 3, the number of the touch sensors 400 are four. The four touch sensors 400 are disposed in an appropriate position of the digital photo frame 100, for example, such as a corner of the digital photo frame 100. Corresponding to the four touch sensors 400, the number of the division portions 310 is four. The division portions 310 can be protrusions or concavities on the housing 300. In the embodiment as shown in FIG. 3, the division portions 310 may be arranged in a cross shape. The arrangement of the division portions 310 are arbitrary and can be set according to need, for example, in the embodiment as shown in FIG. 4, the division portions 310 may be arranged in a rectangular shape.

Each of the touch sensors 400 is further assigned an identification (ID), such as that shown in FIG. 3, and is capable of generating a signal with the ID when being touched. The processing unit 500 receives signals from the touch sensors 400 and recognizes which touch sensor 400 outputs the signals according to the sensor ID. For example, the processing unit 500 recognizes the port to which the touch sensor 400 is connected and recognizes which touch sensor 400 outputs the signal according to the sensor ID. After identifying which touch sensor 400 outputs the signal, the processing unit 500 performs a predetermined function.

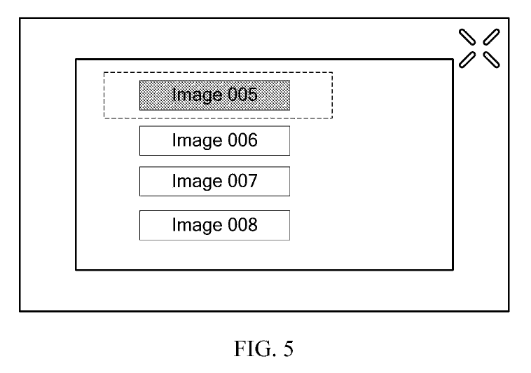

In the embodiment as shown in FIG. 5, the panel display 200 provides a user interface. The user interface shows a plurality of menu items. The digital photo frame 100 further provides a selection area. The selection area is highlighted in a predetermined manner, for example, such as, being bordered by a dashed rectangle. When a menu item is positioned in the selection area, the menu item is in a selectable state and features of the menu item may be altered to indicate its selectable state such as changing the color of the menu item.

If, for example, the touch sensor 400 with ID 01 and the touch sensor 400 with ID 02, as shown in FIG. 3, are activated in sequence, the processing unit 500 performs a function of moving menu item/s upwards a predetermined distance. That is, every time the user touches and slides from the touch area corresponding to the touch sensor 400 with ID 01 to the touch area corresponding to the touch sensor 400 with ID 02 with their finger, the menu item, which is below the menu item in the selection area, is moved into the selection area. Further from this example, if the user wants to move the menu item “Image 0008” to the selection area, as shown in FIG. 5, he can just do the sliding movement three times. With the design of the division portions 310, the user can precisely position menu items by merely controlling the number of times they impart a sliding touch to the touch sensitive area.

Although described with respect to FIG. 5, the function performed by the processing unit 500 is not limited thereto. In addition, the digital photo frame 100 may also include other user interfaces, in such case, the same sliding movement may correspond to different function in different user interfaces.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electronic device comprising:
a housing comprising a plurality of touch areas and division portions, each division portion being disposed between two adjacent touch areas of the plurality of touch areas;
a plurality of touch sensors disposed within the housing, each sensor being corresponding to one of the plurality of touch areas;
a processing unit configured for identifying signals from the plurality of touch sensors and performing functions corresponding to the signals.

2. The electronic device according to claim 1, wherein the electronic device is a digital photo frame.

3. The electronic device according to claim 1, wherein the division portions are protruded from the housing.

4. The electronic device according to claim 1, wherein the division portions are concaved from the housing.

5. The electronic device according to claim 1, wherein the number of the plurality of touch sensors is four.

6. The electronic device according to claim 2, wherein the division portions and the touch areas are arranged in a corner of the digital photo frame.

7. The electronic device according to claim 5, wherein the division portions are arranged in a rectangular shape.

8. The electronic device according to claim 5, wherein the division portions are arranged in a cross shapes.

9. The electronic device according to claim 1, wherein each of the touch sensors is assigned an identification, the processing unit identifies each of the touch sensors by the identification thereof.
